(19) United States
(12) Patent Application Publication
(10) Pub. No.: US 2011/0290826 A1
(43) Pub. Date: Dec. 1, 2011

(54) Structure for Storing Perishable Liquid

(76) Inventor: David R. Harris, Burson, CA (US)

(21) Appl. No.: 12/790,989

(22) Filed: Jun. 1, 2010

(51) Int. Cl. B67D 7/58; B67D 7/60

(52) U.S. Cl. 222/319; 222/386

(57) ABSTRACT

Disclosed herein is a structure for storing and preserving perishable liquids, including a container having a central opening and a plunger, sized and shaped to fit within the central opening. The plunger having means to seal the container and the plunger being slidable thereto. The container has a bottom defining a detent extending toward the central opening. And, the plunger has a bottom end zone with a similar detent. The plunger has a central internal passageway and a cap for sealing one of the passageways. The plunger induces pressure on the liquid and the cap maintains the pressure for preserving the liquid.

### PRIOR APPLICATIONS

This application is related to prior filed application, U.S. Ser. No. 11/963,706, filed Dec. 21, 2007, by the same inventive entity and under the same title as a Continuation-In-Part.

### FIELD OF THE INVENTION

This invention generally relates to the field of storing perishable liquids. More particularly, this invention relates to structure for storing perishable liquids, which include wine and the like.

### BACKGROUND OF THE INVENTION

As is well known, upon removing a wine cork, the shelf life of wine is extremely short. For example, upon opening a bottle of red wine, it is estimated that one should not drink it beyond 72 hours even where one is meticulous about recorking the bottle. In response, consumers have been provided with a wide variety of wine and other perishable liquid storage devices.

Wine, decanters have been a popular way of serving wine at parties and during dining occasions. However, decanters are not designed to store and preserve perishable liquids and more than simply re-inserting the cork back into the original bottle. In fact, many such decanters do not even come with a top to seal the container.

However, some have taken the additional step of attempting to preserve wine once it's been opened by creating a vacuum seal with a new type of cork. Unfortunately, the results of these devices have also been found lacking. Some have attempted to create a whole new decanter and use a specifically designed cork and create a vacuum seal there between. Similarly, these devices have fallen short of their intended goal.

Additionally, an enemy of certain liquids, particularly, wine is oxygen. When wine is exposed to oxygen it causes oxidation and a loss of flavor. It would be advantageous if there were a storage device, which got rid of at least some of the oxygen while storing the liquid.

Thus what is needed is a perishable liquid storage device which is easy to use and can store such liquids for a considerable period of time without damage. In the case of wine this is especially important so that the original flavor may be preserved as long as possible.

### SUMMARY OF THE INVENTION

A structure for storing and preserving perishable liquids, including a container having a central opening and a plunger, sized and shaped to fit within the central opening. The plunger having means to seal the container and the plunger being slidable thereto. The container has a bottom defining a detent extending toward the central opening. And, the plunger has a bottom end zone with a similar detent. The plunger has a central internal passageway and a cap for sealing one of the passageways. The plunger induces pressure on the liquid and the cap maintains the pressure for preserving the liquid.

It is an object of this invention to provide a structure for storing and preserving perishable liquids.

It is an additional object of this invention to provide such a structure, which includes an element for providing pressure on the liquid to be preserved and the ability to maintain that pressure for preservation of the perishable liquid.

The structure in accordance with this invention, comprises:

a container for holding the liquid, the container having a central opening; and

a plunger for inducing pressure on the liquid, while the liquid is held in the container, the plunger being sized and shaped to fit matingly within the container, the plunger having a central opening, the plunger creating at least a partial seal with the container and being slidable with respect thereto and the plunger including cap for sealing one end of the plunger.

In another exemplary embodiment, the structure for a storage device in accordance with this invention comprises:
container means for holding the liquid, the container means including means for closing the container, the container means having a central opening; and
means for inducing pressure on the liquid, while the liquid is held in the container means, the pressure inducing means being sized and shaped to fit matingly within the means for storing the liquid and having a central opening to allow liquid in the storage means to flow there through, the pressure inducing means creating at least a partial seal with the container means and being slidable with respect thereto and the pressure inducing means including cap means for sealing the pressure inducing means.

In an exemplary embodiment, the bottom of the container and the bottom of the plunger are in a frusto-conical shape and compatibly sized and shaped. This assists in inducing pressure and preserving the liquid. This also assists with removing the liquid from the apparatus of the invention, since the liquid flows over the curved edges of the plunger.

In another exemplary embodiment of the invention the apparatus includes guide means for guiding the plunger as it is moved toward the bottom of the container in the central opening. In one particular embodiment of the guide means the container includes a lid with a central opening sized and shaped for slidable guiding contact with the plunger.

It will be appreciated that as the plunger is pushed toward the bottom of the container the air in the container is removed through the open top end of the plunger. Thereby, removing oxygen from the container during storage.

It is an advantage of this invention to provide such a storage device, which preserves the details of the taste of wine stored therein even after being opened from in its original bottle.

It is an additional advantage of this invention to allow easy removal of the liquid from the apparatus.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a perspective view of the storage apparatus in accordance with this invention.

FIG. 2 is a partially cut away perspective view of the storage apparatus in accordance with this invention.

FIGS. 3 & 4 are cross sectional plan views illustrating steps of using the storage apparatus in accordance with this invention.

FIG. 5 is a perspective view of the storage apparatus in accordance with this invention fully assembled.

FIG. 6 is a partially cut away perspective view of the storage apparatus in accordance with this invention.

FIG. 7 is a cross sectional plan view illustrating another exemplary embodiment of the storage apparatus in accordance with this invention.

FIG. 8 is a cross sectional plan view illustrating another exemplary embodiment of the storage apparatus in accordance with this invention.

### DETAILED DESCRIPTION OF THE INVENTION

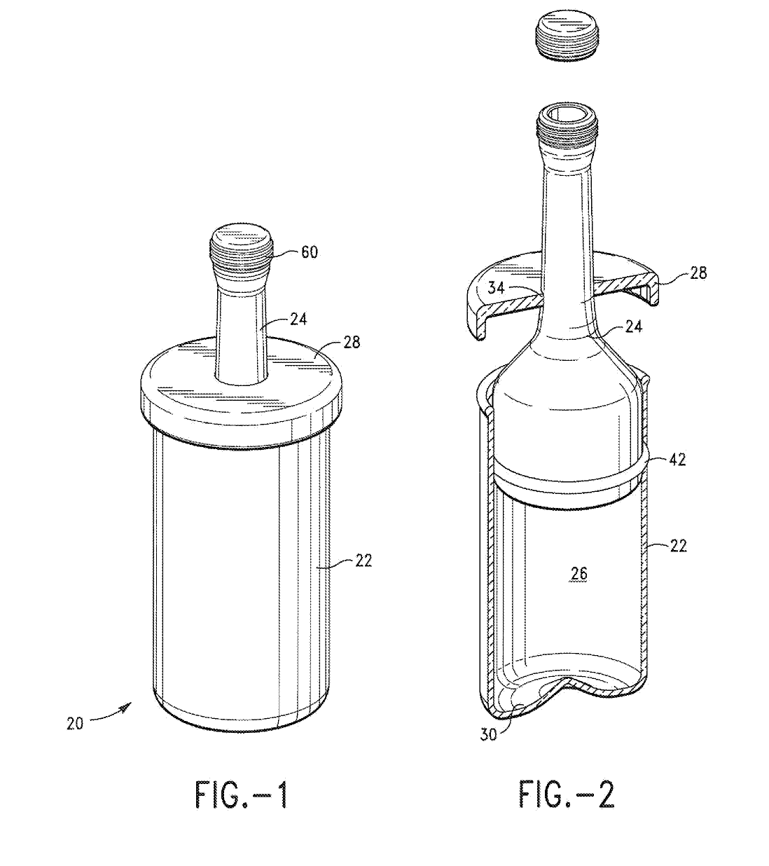

An exemplary embodiment of the storage apparatus in accordance with this invention generally denoted by the numeral 20 will now be described with reference to FIGS. 1-5. The apparatus includes a container 22 and a plunger 24. The container 22 has central opening 26 for allowing liquid to be stored in the container. Additionally, the container 22 includes a lid 28, which is force fit over the sides of the container 22.

Additionally, the container 22 has a bottom 30 and the bottom 30 has a detent 32. The detent 32 projects inwardly into the container 22; the detent 32 projection is toward the central opening 26. In cross section, as best seen in FIGS. 3 & 4, the detent 32 defines a frusto-conical shape.

The lid 28 has central opening 34. The central opening serves as a guide for guiding the plunger as it is thrust toward the bottom of the container for inducing pressure on the liquid. The central opening 34 is sized and shaped for such slidable, guiding contact and in one exemplary embodiment (not shown) includes a hard plastic ring insert around the central opening to assist with slidability. As seen in FIGS. 1-4, the plunger 24 fits snugly, but in sliding contact within the central opening 34.

The plunger 24 is sized and shaped to fit matingly within the container 22. The plunger 24 is slidable with respect to the container 22 and thus capable of inducing pressure upon the liquid held in the container 22.

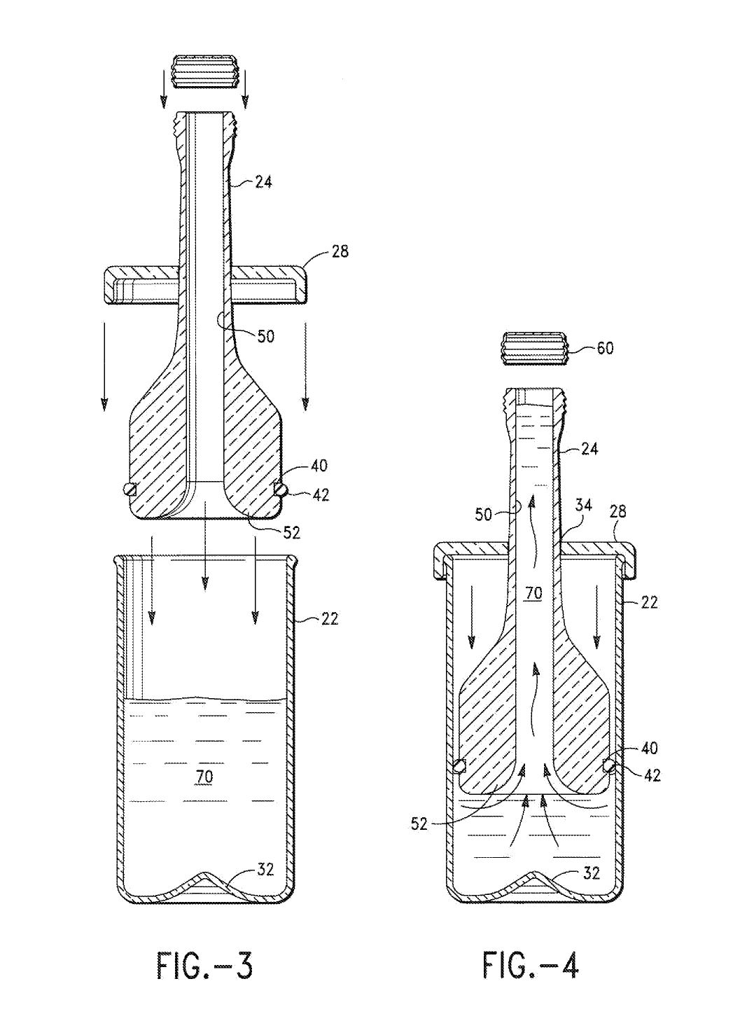

The plunger 24, in an exemplary embodiment, includes a means to create a seal between the container 22 and that portion of the plunger 24 within the container 22. In an exemplary embodiment, the plunger 24 has a groove 40 and an o-ring 42 fits within the groove 40, as best seen in FIGS. 3 & 4. As illustrated in FIGS. 2-4, the o-ring 42 seals the container 22 by providing a seal of the plunger 24 with the walls of the container 22. Nevertheless, the plunger 24 is slidable against the walls of the container 22 even with the o-ring 42 in place.

As clearly seen in FIGS. 3 and 4, the plunger 24 has an elongated shape which is sized and shaped to fit compatibly within the container 22. The plunger 24 has a central opening 50 extending from one end of the plunger 24 through to the other end defining a central passageway. The plunger 24 includes a cap 60 for sealing the top end of the plunger 24. In an exemplary embodiment, the top of the plunger 24 has threads and the cap 60 has matching, compatible threads, which, when screwed down provides a seal for the top of the plunger 22. As can be appreciated, once the top of the plunger 24 is sealed with the cap 60, pressure that was induced upon the liquid is maintained throughout the container 22.

In cross section, as illustrated best in FIGS. 3 and 4, the plunger 24 has a bottom end zone 52. The bottom end zone 52 defines, in cross-section, a frusto-conical shape, which matches generally and is compatible with the frusto-conical shape of the detent 32. It has been found in use that the frusto-conical shape provides an added means for maintaining pressure. Additionally, it has been found that the frusto-conical shape provides a means to assist the liquid to easily flow from the container 22. Thus, the apparatus 20, in accordance with the invention, provides a means for easily removing liquid stored in the container 22.

In Use

In use, the user removes lid 28 and the plunger 24 from the container 22 and pours the liquid 70 to be preserved into the container 22. Such liquid could be wine or any other liquid, which is desired to be stored. Clearly, the liquid if perishable benefits most from the apparatus 20, in accordance with this invention. The plunger 24 is snugly fit to the container 22 with the walls of the container 22 contacting the o-ring 42. The lid 28 is slid over the top of the plunger 24 and fit onto the walls of the container 22. In an exemplary embodiment, the lid 28 is force fit over the edge of the walls of the container 22, as shown clearly in the drawing. This provides a stable base from which the plunger 24 is inserted into the central opening 34 of the lid 28 for guiding the plunger 24 on its downward journey to the bottom of the container 22.

As discussed above, the plunger 24 is slidable with respect to the container 22. The plunger 24 bottom is slid toward the container bottom 30 while being guided by the central opening 34. This action drives the liquid 70 into the internal passageway 50 of the plunger 24, as is best shown in FIG. 4. Upon the liquid reaching the desired level in the apparatus, the cap 60 is applied to the top of the plunger 24 and in the exemplary embodiment screwed down to maintain the pressure created by plunger 24 against the liquid 70.

In order to remove liquid from the apparatus 20 of the instant invention, the cap 60 is removed and liquid 70 is simply poured through the internal passageway 50 of the plunger 24. It will be appreciated that because of the frusto-conical shape, liquid easily flows past the curved bottom end zone 52 of the plunger 24. In order to reseal the apparatus 20 of the instant invention, the plunger bottom end zone 52 is pushed down toward the detent of the container 22, inducing pressure again upon the liquid 70 and maintaining that pressure upon the liquid by screwing down of the cap 60 onto the top of the plunger 24.

It will be appreciated that as the plunger is pushed toward the bottom of the container, the air in the container is removed through the open top end of the plunger. Thereby, removing oxygen from the container during storage. And, in the case of wine, reducing the degree of oxidation.

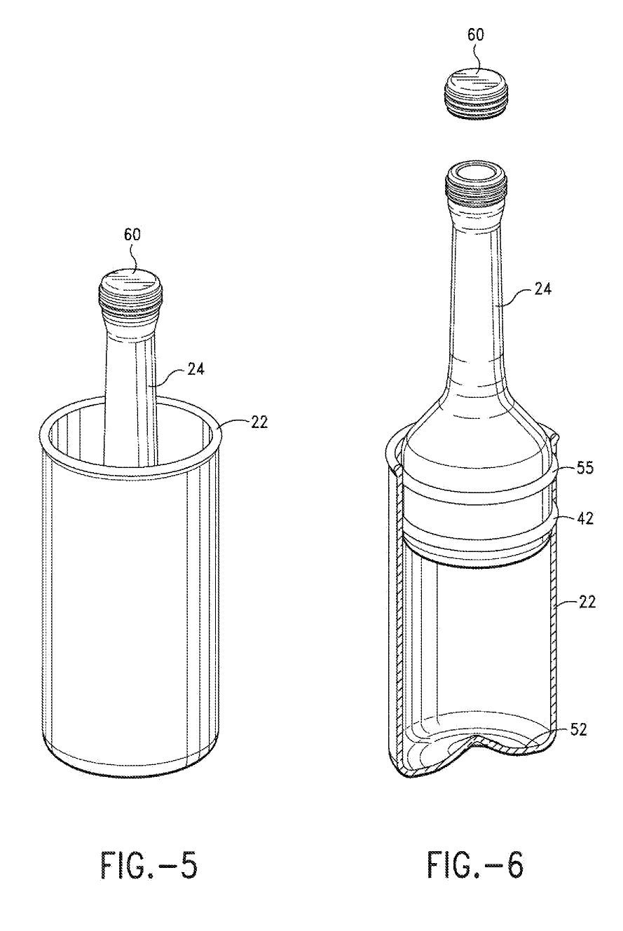

In another exemplary embodiment, as shown in FIGS. 5 and 6, the plunger 24 includes a pair of grooves 40 and a single o-ring 42 and a guiding ring 55. In this embodiment, the container lid 28 is not necessary. Instead, in this exemplary embodiment, the plunger's movement is guided toward the bottom of the container by the ring 55. In an exemplary embodiment, the ring 55 is made from a hard plastic material that slides easily with the outer surface of the plunger 28, guiding the plunger 28 as it journeys toward the bottom of the container 22. Thus, the lid 28 is therefore eliminated in this embodiment.

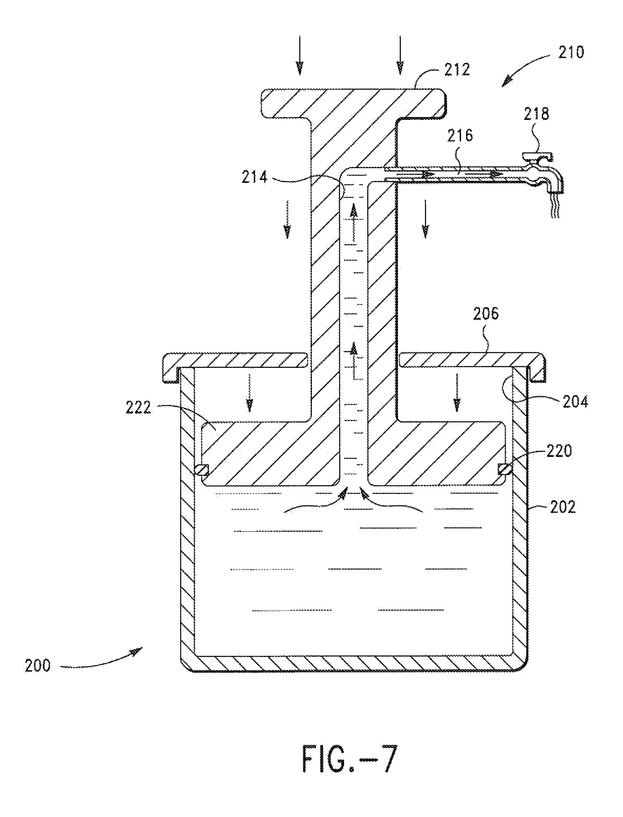

With particular reference to FIG. 7, there is shown another exemplary embodiment of the storage device in accordance with the invention. The storage device generally indicated by numeral 200 includes a container 202 having a central opening 204 and a lid 206 for covering a substantial portion of the central opening 202. The lid 206 covers the central opening, however, the lid 206 has an opening 208, itself, which defines guide means, as will be appreciated hereinafter.

The storage device 200 includes a plunger assembly generally indicated by the numeral 210. The plunger assembly 210 includes a plunger 212. The plunger 212 has a central opening 214 and an outlet 216. The outlet 216 includes a control valve 218.

The control valve 218 can be opened while the plunger 212 moves toward the bottom of the container 202. As will be appreciated from FIG. 7, there being no other opening in the container 202, once the air in the container has been removed, and contact with the liquid in the container is made, liquid from the container will enter the central opening 214 and flow along such a path that it will enter the outlet 216. With continued pressure on the plunger 212 moving the plunger 212 toward the bottom of the container 202, liquid from the container 202 will flow into the outlet valve 218. Providing that the outlet valve 218 is opened, liquid from the container 202 will flow there through and in due course empty the container 202.

In order to make an airtight assembly, the plunger assembly 210 includes a washer or O-ring 220. The O-ring wraps around the exterior circumference of the bottom portion 222 of the plunger 212. The O-ring provides a friction feel to the user as the user depresses the plunger 212 through operation to remove liquid from the container 202. The O-ring 220 provides an airtight seal between the plunger 212 and the container 202, similar to the manner and construction of the earlier described embodiments.

In use, in order to extract liquid, such as wine, from the container 202, the plunger 212 is urged toward the floor of the container 202 as shown by the downward arrows in FIG. 7. Since, there is no other avenues of escape, the wine is forced through the central opening 214 and out the outlet 216 and through the outlet valve 218. As will be appreciated the outlet valve 218 can be opened or closed for convenience.

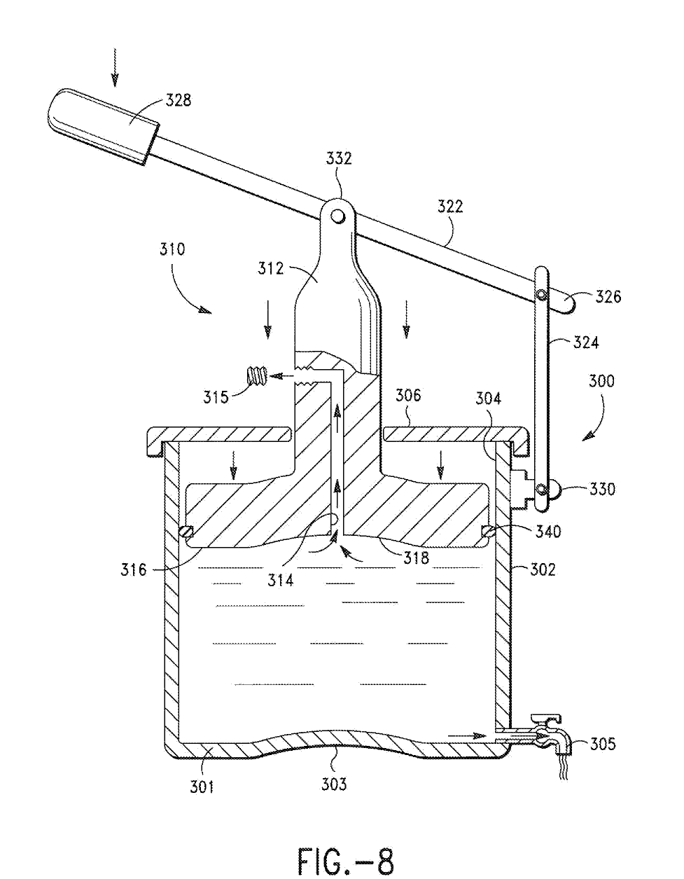

With respect to FIG. 8, there is shown another exemplary embodiment of the storage device, generally indicated by the numeral 300. The storage device 300 includes a container 302 having a central opening 304 and a lid 306 for covering a substantial portion of the central opening 302. The lid 306 covers the central opening 304, however, the lid 306 has an opening 308, itself, which defines guide means for the plunger, as will be appreciated hereinafter.

The container has a bottom 301 with a detent 303. Additionally, the bottom 301 includes an outlet valve 305. As explained below, upon activation of the plunger, air in the container 302 is evacuated through the plunger and liquid is dispensed by using the bottom outlet valve. In order to facilitate such dispensing, the bottom 301 has a detent 303.

The storage device 300 includes a plunger assembly generally indicated by the numeral 310. The plunger assembly 310 includes a plunger 312. The plunger 312 has a central opening 314 defining an air outlet. The plunger 312 has a bottom 316 having a detent 318. The detent 318 matches the curvature of the detent 303. This facilitates in the smooth flow of liquid through the outlet valve 305, and the flow of air through the air outlet 314. Additionally, the detents 303, 318 facilitate a minimum of air entering the container 302.

In order to prevent air from returning into the container 302, the air outlet 314 is provided with a plug 315, allowing air to escape after liquid is added to the container 302. In order to have the air escape through the air outlet 314, the plunger is activated pushing out the air. After the air has escaped through outlet 314, the plug is re-inserted into the outlet 314 for sealing the container 302.

In an alternative exemplary embodiment, the plug 315 is replaced by a pressure relief valve, which releases the pressure on the inside of the container as needed. This operation can take place either manually or through sensors without having the user present.

The plunger assembly 310 includes a handle assembly 320. The handle assembly 320 includes a handle 322 and a support rod 324. The handle 322 has a distal end 326 and a proximal end 328. The support rod 324 is hingedly connected to the container 302 at connection member 330.

Additionally, the handle 322 is hingedly connected to the support at the distal end 326. The handle 322 is also hingedly connected to the top of the plunger 312. The top of the plunger 312 includes a hinge 332 providing a connection point for the handle 322 between the proximal and distal ends of the handle.

The proximal end 328 is designed for accommodating the hand of a user. In the exemplary embodiment of FIG. 8, the proximal end 328 includes a grip for hand support.

In order to make the plunger assembly 310 airtight, the plunger assembly 310 includes a washer or O-ring 340. The O-ring 340 wraps around the exterior circumference of the plunger 312. The O-ring 340 provides a friction feel to the user as the user depresses the plunger 312 through operation to evacuate air and dispense liquid from the container 302. The O-ring 340 provides an airtight seal between the plunger 312 and the container 302, similar to the manner and construction of the earlier described embodiments.

In use, in order to dispense liquid, such as wine, from the container 302, the plunger 312 is urged toward the floor of the container 302 as shown by the downward arrows in FIG. 8. As the plunger 312 is moved in the direction of the arrows, wine flows through the opened outlet valve 305 and into the consumer's glass, for example. Upon the desired amount of wine, for example, being dispensed, the valve 305 is closed, once again providing a sealed container for the liquid.

In an alternative embodiment, the container 302 is provided with a safety relief valve. In case the user fails to appreciate that the valve 305 is closed, valve 305 or for example valve 315 or a separate valve entirely, is designed to relief pressure without causing harm to the container 302 or the user. It will be appreciated that the escape of liquid in the container is possible when the safety valve is activated.

While the foregoing detailed description has described several embodiments of the storage apparatus in accordance with this invention, it is to be understood that the above description is illustrative only and not limiting of the disclosed invention. Particularly, there can quite a few varieties of means for guiding the plunger and also of creating and maintaining a seal between the plunger and the container. It will be appreciated that the specific mechanical objects that are used to provide this function remain unimportant, in and of themselves. However, the function of these elements is important and all such variations are all within the spirit and scope of this invention. It will be appreciated there are also various container shapes and plunger shapes and sizes are unimportant, as long as the functions of these elements are clearly provided, all such variations are suitable for use in the exemplary embodiments discussed above and that there are numerous embodiments that are not mentioned but within the scope and spirit of this invention. Thus, the invention is to be limited only by the claims as set forth below.

What is claimed is:

1. An apparatus for preserving perishable liquids under pressure, the apparatus, comprises:
container means for holding the liquid, the container means including means for closing the container, the container means having a central opening; and
means for inducing pressure on the liquid, while the liquid is held in the container means, the pressure inducing means being sized and shaped to fit matingly within the means for storing the liquid and having a central opening to allow liquid in the storage means to flow there through, the pressure inducing means creating at least a partial seal with the container means and being slidable with respect thereto and the pressure inducing means including cap means for sealing the pressure inducing means.

2. The apparatus of claim 1, wherein the pressure inducing means defines a plunger having an elongated body and having an internal passageway there through and the cap means for sealing one end of the internal passageway.

3. The apparatus of claim 1, wherein the container means has a bottom end and wherein the bottom end has inward projecting portion defining a detent and the cross section of the detent is in a frusto-conical shape.

4. The apparatus of claim 3, wherein the pressure inducing means has a bottom end zone of compatible size and shape to the detent.

5. The apparatus of claim 1, wherein the pressure inducing means has means on the outer surface for creating a seal between the pressure inducing means and the container means.

6. The apparatus of claim 4, wherein the pressure inducing means has a means on the outer surface for creating a seal between the pressure inducing means and the container means.

7. The apparatus of claim 5, wherein means for creating a seal defines an O-ring.

8. The apparatus of claim 7, wherein means for creating a seal includes at least two O-rings.

9. The apparatus of claim 8, wherein means for creating a seal includes a series of O-rings.

10. The apparatus of claim 1, wherein the container means includes guide Means for guiding the pressure inducing means for slidable movement through the container and where the guide means comprises a lid covering the central opening of the container and the lid having a central opening sized and shaped for siding movement of the pressure inducing means with respect to the container means.

11. The apparatus of claim 1, wherein the means for sealing the pressure inducing means comprises a cap and wherein the top of the pressure inducing means has threads and wherein the cap has compatible threads for sealing the top of the pressure inducing means.

12. An apparatus for preserving perishable liquids under pressure, the apparatus, comprises:
a container for holding the liquid, the container having a central opening; and
a plunger for inducing pressure on the liquid, while the liquid is held in the container, the plunger being sized and shaped to fit matingly within the container, the plunger having a central opening, the plunger creating at least a partial seal with the container and being slidable with respect thereto and the plunger including cap for sealing one end of the plunger.

13. The apparatus as set forth in claim 12, wherein the container includes a lid for closing the central opening, the lid having a central opening for allowing the plunger to slide there through.

14. The apparatus as set forth in claim 12, wherein the container includes a means for guiding the plunger for slidable movement within the container.

15. The apparatus as set forth in claim 12, wherein the container has a bottom defining a detent, being inwardly projecting toward the central opening and wherein the detent has a frusto-conical shape and wherein the plunger is similarly and compatibly sized and shaped.

16. An apparatus for preserving perishable liquids under pressure, the apparatus, comprises:
a container for holding the liquid, the container having a central opening, the container including means for creating a seal of the container; and
a plunger assembly for inducing pressure on the liquid, while the liquid is held in the container means, the plunger assembly including a plunger for inducing pressure on the liquid and the plunger having a central opening for allowing liquid in the container to flow there-through, the plunger assembly creating at least a partial seal with the container and the plunger being slidable with respect, the plunger having an outlet and a control valve for selectively turning on and off the flow of liquid.

17. The apparatus as set forth in claim 16, wherein the plunger includes an O-ring between the outer circumference of the plunger and the container for maintaining at least a partial airtight seal.

18. An apparatus for preserving perishable liquids under pressure, the apparatus, comprises:
a container for holding the liquid, the container having a central opening, the container including means for creating a seal of the container; and
a plunger assembly for inducing pressure on the liquid, while the liquid is held in the container means, the plunger assembly including
a plunger for inducing pressure on the liquid,
the plunger having a central opening for evacuating air from the container,
the plunger having a central structure including a hinge, and the plunger including a handle and a support rod, the handle being hingedly connected to the hinge and the support rod, the support rod being connected to the container, and
the container having a bottom opening defining an outlet channel and an outlet valve for allowing liquid in the container to flow there through.

19. The apparatus as set forth in claim 18, wherein the plunger central opening includes valve means for evacuating air from the container, but not allowing air into the container.

20. The apparatus as set forth in claim 18, wherein the plunger includes an O-ring between the outer circumference of the plunger and the container for maintaining at least a partial airtight seal.
